(19) United States
(12) Patent Application Publication
(10) Pub. No.: US 2018/0027241 A1
(43) Pub. Date: Jan. 25, 2018

(54) Method and Apparatus for Multi-Level Region-of-Interest Video Coding

(71) Applicant: MEDIATEK INC., Hsin-Chu (TW)

(72) Inventors: Tung-Hsing WU, Chiayi City (TW); Li-Heng CHEN, Tainan City (TW); Han-Liang CHOU, Baoshan Township (TW)

(21) Appl. No.: 15/651,151

(22) Filed: Jul. 17, 2017

Related U.S. Application Data
(60) Provisional application No. 62/364,366, filed on Jul. 20, 2016.

(51) Int. Cl. H04N 19/167; H04N 19/176; H04N 19/147; H04N 19/119; H04N 19/124

(52) U.S. Cl. CPC H04N 19/167; H04N 19/119; H04N 19/124; H04N 19/147; H04N 19/176; H04N 19/157

(57) ABSTRACT

A method and apparatus for video encoding with multi-level regions of interest is disclosed. According to the present invention, a target frame in the input video data is configured into multiple-level region-of-interest (ROI) regions. Each target higher-level ROI region is located within one target lower-level ROI region. The multiple-level ROI regions are then encoded according to a plurality of quality levels, where at least two different quality levels are applied to two different multiple-level ROI regions respectively.

### CROSS REFERENCE TO RELATED APPLICATIONS

The present invention claims priority to U.S. Provisional Patent Application Ser. No. 62/364,366, filed on Jul. 20, 2016. The U.S. Provisional Patent Application is hereby incorporated by reference in its entirety.

### FIELD OF THE INVENTION

The present invention relates to video coding. In particular, the present invention relates to coding techniques to facilitate multi-level region-of-interest (ROI) video coding.

### BACKGROUND

Video data requires a lot of storage space to store or a wide bandwidth to transmit. Along with the growing high resolution and higher frame rates, the storage or transmission bandwidth requirements would be formidable if the video data is stored or transmitted in an uncompressed form. Therefore, video data is often stored or transmitted in a compressed format using video coding techniques. The coding efficiency has been substantially improved in recent years by using newer video compression standards such as H.264/AVC, VP8, VP9 and the emerging HEVC (High Efficiency Video Coding) standard. In order to maintain manageable complexity as well as to adapt to local video characteristics, an image is often divided into blocks, such as macroblock (MB) or LCU/CU to apply video coding. Video coding standards usually adopt adaptive Inter/Intra prediction on a block basis.

In recent years, the demands for higher video resolution continue to grow. Currently, video devices (e.g. TV, digital video recorder (DVR) and Blu-Ray player) supporting 4K video formats are widely available. Efforts to develop even higher video resolution (e.g. 8K video) have been ongoing for some time. In addition, the frame rate also increases in order to reduce motion artifacts as well as to provide more stable video display. With the growing video resolution and/or frame rate, the bandwidth required to transmit the video contents in new video formats also grows rapidly. On the other hand, virtual-reality contents captured using multiple cameras result in huge amount of video data and also require high bandwidth to transmit. Therefore, it is desirable to applied efficient video coding techniques to further reduce the compressed data associated with high resolution/frame rate video data and virtual reality video data.

FIG. 1 illustrates an exemplary adaptive Inter/Intra video coding system incorporating loop processing. For Inter-prediction, Motion Estimation (ME)/Motion Compensation (MC) 112 is used to provide prediction data based on video data from other picture or pictures. Switch 114 selects Intra Prediction 110 or Inter-prediction data and the selected prediction data is supplied to Adder 116 to form prediction errors, also called residues. The prediction error is then processed by Transform (T) 118 followed by Quantization (Q) 120. The transformed and quantized residues are provided to Rate Distortion Optimization (RDO)/Mode Decision unit 121 to evaluate the cost in terms of rate and distortion for an associated coding mode. The encoder then selects a mode that achieves the best performance measured in the rate-distortion cost. The transformed and quantized residues are then coded by Entropy Encoder 122 to be included in a video bitstream corresponding to the compressed video data. The bitstream associated with the transform coefficients is then packed with side information such as motion, coding modes, and other information associated with the image area. The side information may also be compressed by entropy coding to reduce required bandwidth. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 using Adder 128 to reconstruct video data. The reconstructed video data may be stored in Reference Picture Buffer 134 and used for prediction of other frames. However, the reconstructed video data from REC 128 may be subject to various impairments due to a series of processing. Accordingly, Loop filter 130 (e.g. De-blocking) is often applied to the reconstructed video data before the reconstructed video data are stored in the Reference Picture Buffer 134 in order to improve video quality. For example, deblocking filter (DF) and Sample Adaptive Offset (SAO) have been used in the High Efficiency Video Coding (HEVC) standard. The loop filter information may have to be incorporated in the bitstream so that a decoder can properly recover the required information. Therefore, loop filter information is provided to Entropy Encoder 122 for incorporation into the bitstream. In FIG. 1, Loop filter 130 (e.g. de-blocking filter) is applied to the reconstructed video before the reconstructed samples are stored in the reference picture buffer 134. The system in FIG. 1 is intended to illustrate an exemplary structure of a typical video encoder. It may correspond to the High Efficiency Video Coding (HEVC) system or H.264.

In the encoder side, the quantization process 120 causes distortions by quantizing transform coefficients typically in high precision into a limited number of quantization levels. A larger quantization step size will result in less quantized levels and more concentrated distribution of quantized outputs to achieve high compression ratio. In this case, the video quality is subject to a higher degree of distortions. On the other hand, a smaller quantization step size will result in more quantized levels and more spread distribution of quantized outputs to preserve higher picture quality. In this case, it results in low compression ratio (i.e., more output bits). Therefore, quantization level has been used as a main bitrate control mechanism in various video coding systems.

FIG. 2 illustrates a system block diagram of a corresponding video decoder for the encoder system in FIG. 1. Since the encoder also contains a local decoder for reconstructing the video data, some decoder components are already used in the encoder except for the entropy decoder 210. Furthermore, only motion compensation 222 is required for the decoder side. The switch 224 selects Intra-prediction or Inter-prediction and the selected prediction data are supplied to reconstruction unit (REC) 128 to be combined with recovered residues. Besides performing entropy decoding on compressed residues, entropy decoding 210 is also responsible for entropy decoding of side information and provides the side information to respective blocks. For example, the entropy decoder also decodes information related to Intra mode coding (e.g. mode number for Intra prediction) and Inter mode coding (e.g. motion vectors). The MVs are then provided to motion compensation 222 for locating reference blocks. The residues are processed by IQ 124, IT 126 and subsequent reconstruction process to reconstruct the video data. Again, reconstructed video data from reconstruction unit (REC) 128 undergo a series of processing including IQ 124 and IT 126 as shown in FIG. 2 and are subject to coding artifacts. The reconstructed video data are further processed by Loop filter 130.

In video coding systems, a frame is often partition into multiple slices to offer the capability for parallel processing. Also, the slice structure may limit data dependency within each slice. The “slice” term has been commonly used in various video coding standards, such as MPEG2/4, H.264, HEVC, RM, AVS/AVS2, etc. Furthermore, the basic coding unit has also been used of video standard. For example, Macroblock (MB) has been used in AVC, MPEG4, etc. Super Block (SB) has been used in VP9 standard. Coding Tree Unit (CTU) has been used in HEVC (high efficiency video coding). Furthermore, a coding structure, the CTU Row, SB row and MB row have also been used. In order to increase video compression ratio, spatial reference data and temporal reference data are used for prediction.

While efficient video coding can substantially reduce bit rate to transmit the underlying video data, the bandwidth may still impose a challenging issue for various transmission environments, such as bandwidth constrained wireless networks or crowded internet environments. Therefore, it is desirable to develop techniques that can help to alleviate the bandwidth issue associated with high resolution/frame rate video data and virtual reality video data.

### BRIEF SUMMARY OF THE INVENTION

A method and apparatus for video encoding with multi-level regions of interest is disclosed. According to the present invention, a target frame in the input video data is configured into multiple-level region-of-interest (ROI) regions. Each target higher-level ROI region is located within one target lower-level ROI region. The multiple-level ROI regions are then encoded according to a plurality of quality levels, where at least two different quality levels are applied to two different multiple-level ROI regions respectively.

The plurality of quality levels may correspond to a set of level offsets and each level corresponds to one quality level offset from a base quality level and the base quality level can be selected as the quality level of a designated multiple-level ROI region. The designated multiple-level ROI region may correspond to a non-ROI region or a lowest-level region.

Each quality level may correspond to one quantization parameter and each level offset may correspond to one offset value representing one target quantization parameter offset from a base quantization parameter associated with a non-ROI region or a lowest-level region. Each level offset can be associated with a target bit allocation.

In one embodiment, the target frame includes at least two images from at least two cameras. For example, the target frame consists of a left image and a right image, and the left image is configured into first multiple-level ROI regions and the right image is configured into second multiple-level ROI regions different from the first multiple-level ROI regions.

In one embodiment, the target frame is partitioned into non-overlapping coding units and encoding process is applied to each coding unit. Furthermore, boundaries of each ROI region can be aligned with boundaries of one or more coding units.

In one embodiment, a group of pixels in a highest-level ROI region are coded using a highest quality level. In another embodiment, different target frames in the input video data are configured into different multiple-level ROI regions. Also, different pluralities of quality levels can be used for two different target frames.

In one embodiment, the multiple-level ROI regions can be encoded using rate control. The rate control can be achieved by controlling quantization parameters for blocks of pixels within the target frame. Controlling the quantization parameters for blocks of pixels within the target frame can take into consideration of the multiple-level ROI regions and the plurality of quality levels.

### BRIEF DESCRIPTION OF THE DRAWINGS

FIG. 1 illustrates an exemplary adaptive Inter/Intra video coding system incorporating loop processing.

FIG. 2 illustrates a system block diagram of a corresponding video decoder for the encoder system in FIG. 1.

FIG. 3 illustrates an example of ROI setting according to an embodiment of the present invention, where a picture frame is organized into as three different levels of ROI (i.e., non-ROI region, level 1 ROI region and level 2 ROI regions).

FIG. 4 illustrates another example of ROI setting according to an embodiment of the present invention, where the video frame contains a left image and a right image from two cameras of a stereo video system respectively.

FIG. 5 illustrates yet another example of ROI setting according to an embodiment of the present invention, where a picture frame is partitioned into four different ROI regions (i.e., non-ROI region, level 1 ROI region, first level 2 ROI regions and second level 2 ROI regions).

FIG. 6 illustrates a flowchart of an exemplary coding system according to an embodiment of the present invention, where the frame is configured into multiple-level ROI regions and the multiple-level ROI regions are encoded according to a plurality of quality levels.

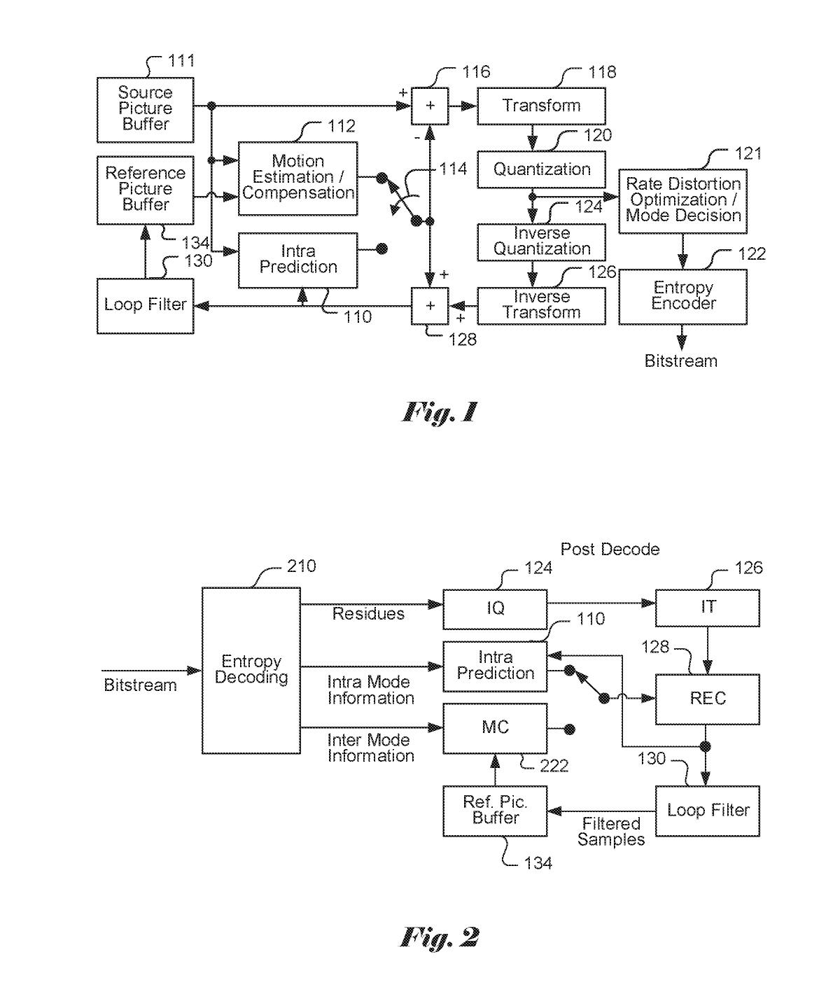

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

In order to alleviate the bandwidth issue associated with high resolution/frame rate video data and virtual reality video data, the present invention discloses multi-level region-of-interest video coding, where different video quality levels are applied to different regions of interest. For high resolution video, a viewer often focuses on a particular region of the high resolution picture. For example, the viewer may focus on the center of the picture or a moving object (e.g. a basketball player in a ball game) in the picture. In such cases, the central region or the region enclosing the basketball player is designated as a selected region of interest with one level of quality different from the rest region(s) of the picture. Accordingly, a higher quality level can be assigned to the selected region for video coding. Alternatively, a lower quality level can be assigned to the remaining region(s) of the picture. The decision of multi-level regions of interest is made by or provided to the coding system and the encoder applied one target quality level for each region of interest.

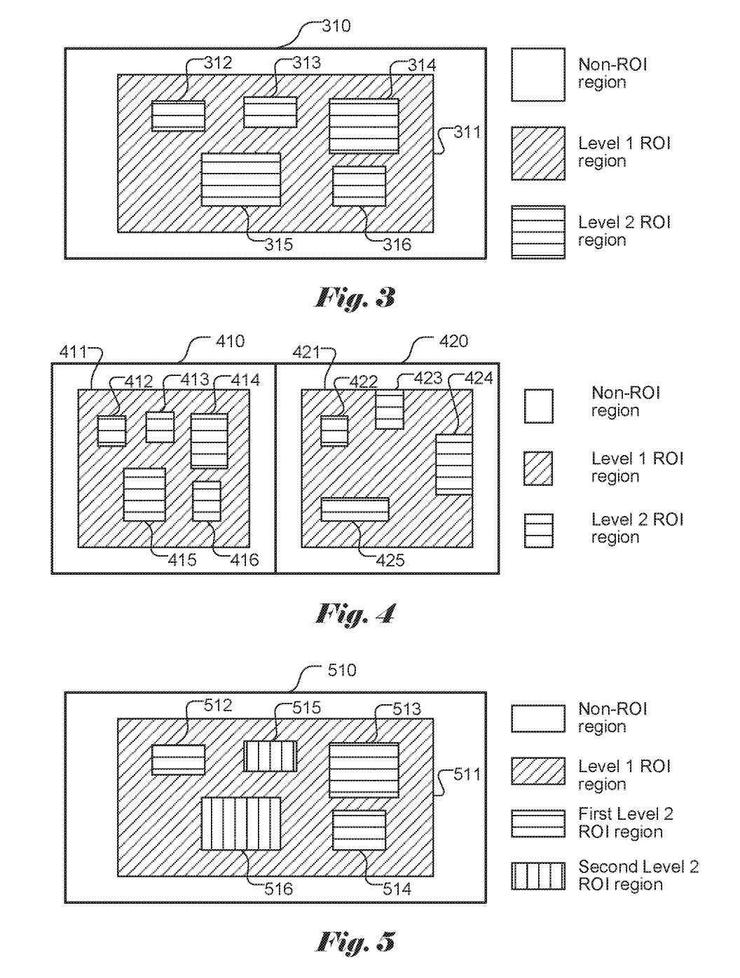

FIG. 3 illustrates an example of ROI setting according to an embodiment of the present invention, where a picture frame 310 is organized as three different levels of ROI (i.e., non-ROI region, level 1 ROI region and level 2 ROI regions). The non-ROI region may also be referred as a level 0 ROI region or a specific ROI region. In this example, the picture frame 310 is designated as non-ROI region. Within the non-ROI region, level 1 ROI region 311 is determined. Furthermore, within level 1 ROI region 311, five level 2 ROI regions (312-316) are determined. According to an embodiment of the present invention, three different quality levels can be applied to the three different regions of interest. The quality level can be measured in relatively with respect to a base region. For example, the quality level for the non-ROI region can be used as the base quality level. The quality levels for other regions can be referred as an offset from the base quality level. For example, the quality level can be controlled via the quantization parameter, which indicates the quantization level selected for the quantization process. In this case, the quality levels for other regions are in a form of level offsets from the base level. In particular, the level offsets correspond to offsets of the quantization parameter.

A coding process for this example is shown as follows. A quantization parameter (e.g. 20) is selected for the base level (i.e., the non-ROI region) and the non-ROI region (i.e., the blank area in FIG. 3) is encoded using quantization parameter 20. For level 1 ROI region (i.e., the area filled with slant lines in FIG. 3), a level 1 offset corresponding to −6 is selected to achieve a high quality level than the non-ROI region. Accordingly, level 1 ROI region is encoded using quantization parameter 14 (i.e., (20−6)=14). Furthermore, for level 2 ROI regions (i.e., the areas filled with horizontal lines in FIG. 3), a level 2 offset corresponding to −12 is selected to achieve an even high quality level than the level 1 ROI region. Accordingly, level 2 ROI regions are encoded using quantization parameter 8 (i.e., (20−12)=8). The level offsets derived as above are used to derive the target quantization parameters. The actual quantization parameter applied to each block of pixels within one ROI region may be modified according to rate control mechanism. As is known in the art, the bit rate control for video coding can be achieved by adjusting coding parameters, such as the quantization parameter. In this example, the initial quantization parameter of non-ROI region is set to 20. However, due to bit-rate control, the quantization parameter of non-ROI region can be changed to a higher or lower value during encoding one video frame. Therefore, the quantization parameters of level 1 and level 2 ROI regions may be changed accordingly.

FIG. 4 illustrates another example of ROI setting according to an embodiment of the present invention, where the video frame contains a left image 410 and a right image 420 from two cameras respectively of a stereo video system. In this example, the left image 410 is designated as non-ROI region. Within the non-ROI region, level 1 ROI region 411 is determined. Furthermore, within level 1 ROI region 411, five level 2 ROI regions (412-416) are determined. The right image 420 is designated as non-ROI region. Within the non-ROI region, level 1 ROI region 421 is determined. Furthermore, within level 1 ROI region 421, four level 2 ROI regions (422-425) are determined. Separate ROI settings are applied to the left image and the right image. Accordingly, the left image is configured into first three levels of ROI (i.e., non-ROI region, level 1 ROI region and level 2 ROI regions) and the right image is also configured into second three levels of ROI. However, the first three levels of ROI are different from the second three levels of ROI. Again, the quality level can be controlled via the quantization parameter, which indicates the quantization level selected for the quantization process. The level offsets correspond to offsets of the quantization parameter with respect to the quantization parameter for the non-ROI region.

A coding process for this example is shown as follows. A quantization parameter (e.g. 20) is selected for the base level (i.e., the non-ROI region) and the non-ROI region (i.e., the blank area in FIG. 4) is encoded using quantization parameter 20. For level 1 ROI region (i.e., the area filled with slant lines in FIG. 4), a level 1 offset corresponding to −6 is selected for both the left image and the right image to achieve a high quality level than the non-ROI region. Accordingly, level 1 ROI regions for the left image and the right image are encoded using quantization parameter 14 (i.e., (20−6)=14). Furthermore, for level 2 ROI regions in the left image (i.e., the areas filled with horizontal lines in the left side of FIG. 4), a first level 2 offset corresponding to −12 is selected to achieve an even high quality level than the level 1 ROI region. Accordingly, level 2 ROI regions in the left image are encoded using quantization parameter 8 (i.e., (20−12)=8). For level 2 ROI regions in the right image (i.e., the areas filled with horizontal lines in the right side of FIG. 4), a second level 2 offset corresponding to −10 is selected to achieve an even high quality level than the level 1 ROI region. Accordingly, level 2 ROI regions in the right image are encoded using quantization parameter 10 (i.e., (20−10)=10). The level offsets derived as above are used as target quantization parameters. The actual quantization parameter applied to each block of pixels within one ROI region may be modified according to rate control mechanism. In this example, the initial quantization parameter of non-ROI region is set to 20. However, due to bit-rate control, the quantization parameter of non-ROI region can be changed to a higher or lower value during encoding one video frame. Therefore, the quantization parameters of level 1 and level 2 ROI regions may be changed accordingly.

FIG. 5 illustrates yet another example of ROI setting according to an embodiment of the present invention, where a picture frame 510 is configured into four different ROI regions (i.e., non-ROI region, level 1 ROI region, first level 2 ROI regions and second level 2 ROI regions). In this example, there are two different level 2 ROI regions, i.e., first level 2 regions and second level 2 regions. Accordingly, while there are only three different levels, there are four different ROI regions. The picture frame 510 is designated as non-ROI region. Within the non-ROI region, level 1 ROI region 511 is determined. Furthermore, within level 1 ROI region 511, three first level 2 ROI regions (512-514) and two second level 2 ROI regions (515-516) are determined. According to an embodiment of the present invention, four different quality levels can be applied to the four different regions of interest. The quality level can be measured in a relative sense with respect to a base region. For example, the quality level for the non-ROI region can be used as the base quality level. The quality levels for other regions can be referred as an offset from the base quality level. For example, the quality level can be controlled via the quantization parameter, which indicates the quantization level selected for the quantization process. In this case, the quality levels for other regions are in a form of level offsets from the base level. In particular, the level offsets correspond to offsets of the quantization parameter.

A coding process for this example is shown as follows. A quantization parameter (e.g. 20) is selected for the base level (i.e., the non-ROI region) and the non-ROI region (i.e., the area filled with slant lines in FIG. 5) is encoded using quantization parameter 20. For level 1 ROI region, a level 1 offset corresponding to -6 is selected to achieve a high quality level than the non-ROI region. Accordingly, level 1 ROI region (i.e., the area filled with slant lines in FIG. 5) is encoded using quantization parameter 14 (i.e., (20−6=14)). Furthermore, for first level 2 ROI regions, a first level 2 offset corresponding to -12 is selected to achieve an even high quality level than the level 1 ROI region. Accordingly, first level 2 ROI regions (i.e., the areas filled with horizontal lines in the right side of FIG. 5) are encoded using quantization parameter 8 (i.e., (20−12=8)). For second level 2 ROI region, a second level 2 offset corresponding to -15 is selected to achieve an even high quality level than the level 1 ROI region. Accordingly, second level 2 ROI regions (i.e., the areas filled with horizontal lines in the right side of FIG. 5) are encoded using quantization parameter 5 (i.e., (20−15=5)).The level offsets derived as above are used as target quantization parameters. The actual quantization parameter applied to each block of pixels within one ROI region may be modified according to rate control mechanism. In this example, the initial quantization parameter of non-ROI region is set to 20. However, due to bit-rate control, the quantization parameter of non-ROI region can be changed to a higher or lower value during encoding one video frame. Therefore, the quantization parameters of level 1 and level 2 ROI regions may be changed accordingly.

In the above example, quality level for the non-ROI region is selected as the base quality and the quality levels for other regions are measured with respect to the base quality level. However, the quality level for one of other regions may also be selected as the base quality level and the quality offset can be measured accordingly.

The inventions disclosed above can be incorporated into various video encoding or decoding systems in various forms. For example, the inventions can be implemented using hardware-based approaches, such as dedicated integrated circuits (IC), field programmable logic array (FPGA), digital signal processor (DSP), central processing unit (CPU), etc. The inventions can also be implemented using software codes or firmware codes executable on a computer, laptop or mobile device such as smart phones. Furthermore, the software codes or firmware codes can be executable on a mixed-type platform such as a CPU with dedicated processors (e.g. video coding engine or co-processor).

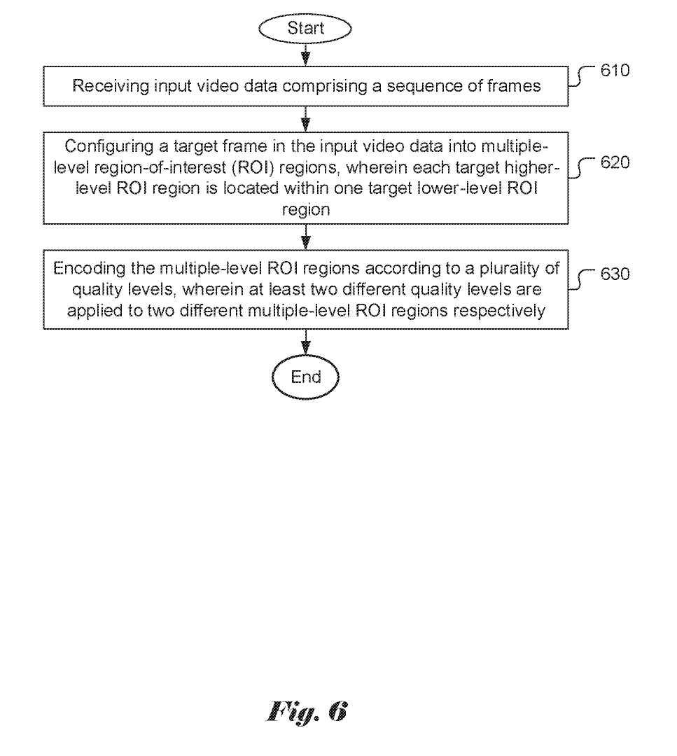

FIG. 6 illustrates a flowchart of an exemplary coding system according to an embodiment of the present invention, where the frame is configured into multiple-level ROI regions and the multiple-level ROI regions are encoded according to a plurality of quality levels. According to this embodiment, input video data comprising a sequence of frames are received in step 610. A target frame in the input video data is configured into multiple-level region-of-interest (ROI) regions in step 620, where each target higher-level ROI region is located within one target lower-level ROI region. Various examples of higher-level ROI region configuration are shown in FIG. 3 through FIG. 5. The multiple-level ROI regions are encoded according to a plurality of quality levels in step 630, where at least two different quality levels are applied to two different multiple-level ROI regions respectively.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video encoding comprising:
receiving input video data comprising a sequence of frames;
configuring a target frame in the input video data into multiple-level region-of-interest (ROI) regions, wherein each target higher-level ROI region is located within one target lower-level ROI region; and
encoding the multiple-level ROI regions according to a plurality of quality levels, wherein at least two different quality levels are applied to two different multiple-level ROI regions respectively.

2. The method of claim 1, wherein the plurality of quality levels correspond to a set of level offsets and each level corresponds to one quality level offset from a base quality level, and wherein the base quality level is selected as the quality level of a designated multiple-level ROI region.

3. The method of claim 2, wherein the designated multiple-level ROI region corresponds to a non-ROI region or a lowest-level region.

4. The method of claim 1, wherein each quality level corresponds to one quantization parameter and each level offset corresponds to one offset value representing one target quantization parameter offset from a base quantization parameter associated with a non-ROI region or a lowest-level region.

5. The method of claim 4, wherein each level offset is associated with a target bit allocation.

6. The method of claim 1, wherein the target frame includes at least two images from at least two cameras.

7. The method of claim 6, wherein the target frame consists of a left image and a right image, and wherein the left image is configured into first multiple-level ROI regions and the right image is configured into second multiple-level ROI regions different from the first multiple-level ROI regions.

8. The method of claim 1, wherein the target frame is partitioned into non-overlapping coding units and encoding process is applied to each coding unit.

9. The method of claim 8, wherein boundaries of each ROI region are aligned with boundaries of one or more coding units.

10. The method of claim 1, wherein a group of pixels in a highest-level ROI region are coded using a highest quality level.

11. The method of claim 1, wherein different target frames in the input video data are configured into different multiple-level ROI regions.

12. The method of claim 1, wherein different pluralities of quality levels are used for two different target frames.

13. The method of claim 1, wherein the multiple-level ROI regions are encoded using rate control.

14. The method of claim 13, wherein the rate control is achieved by controlling quantization parameters for blocks of pixels within the target frame.

15. The method of claim 14, wherein said controlling the quantization parameters for blocks of pixels within the target frame takes into consideration of the multiple-level ROI regions and the plurality of quality levels.

16. An apparatus for video encoding comprising one or more electronic circuits or processors arranged to:
receive input video data comprising a sequence of frames;
configure a target frame in the input video data into multiple-level region-of-interest (ROI) regions, wherein each target higher-level ROI region is located within one target lower-level ROI region; and
encode the multiple-level ROI regions according to a plurality of quality levels, wherein at least two different quality levels are applied to two different multiple-level ROI regions respectively.
